(19) United States
(12) Patent Application Publication
(10) Pub. No.: US 2020/0187546 A1
(43) Pub. Date: Jun. 18, 2020

(54) EFFECTIVE FOAM CONTROL ON PROCESS BEET WASHING WATER BY AUTOMATIC APPLICATION OF ANITFOAM UPON A SET POINT OF AIR CONTENT MEASURED BY SONAR TECHNOLOGY

(71) Applicant: BUCKMAN LABORATORIES INTERNATIONAL, INC., Memphis, TN (US)

(72) Inventors: Marco Ulisse MASCIA, Alfonsine (IT); Bret MAGNESS, Collierville, TN (US); Ivan SMITH, Maryville, TN (US)

(21) Appl. No.: 16/689,774

(22) Filed: Nov. 20, 2019

Related U.S. Application Data
(60) Provisional application No. 62/770,283, filed on Nov. 21, 2018.
(60) Provisional application No. 62/833,242, filed on Apr. 12, 2019.

(51) Int. Cl. A23N 12/02; B01D 19/04; B01D 19/00

(52) U.S. Cl. CPC A23N 12/023; B01D 19/0063; B01D 19/04

(57) ABSTRACT

A beet washing system features a defoamer dosage controller having a signal processor configured to receive signaling containing information about a volumetric percent of entrained air in a process water used for washing beets; and determine corresponding signaling containing information to control a dosage of defoamer provided to the process water to regulate the amount of foam in the process water used for washing the beets.

### CROSS REFERENCE TO RELATED APPLICATIONS

This application claims benefit to provisional application No. 62/770,283, filed 21 Nov. 2018, as well as provisional application No. 62/833,242, filed 12 Apr. 2019, which are both incorporated by reference in their entirety.

### BACKGROUND OF THE INVENTION

### 1. Field of the Invention

This application relates to a system for washing beets; and more particularly to a system for washing beets having foam control.

### 2. Brief Description of Related Art

Defoamer application on beet washing water is done traditionally by usage of dosing pumps, set manually by the operators, who visually inspect the presence of foam into the system and subjectively determine the product dosage to avoid foam build up which may cause severe process upsets. Preventive foam control is obtained by an application of safe dosages to prevent worst case scenarios. Unexpected foam build up is controlled by slug dosage of antifoam or a robust increase of dosage of antifoam for a period needed to make the foam disappear, which can be hours.

By way of example, the following patent documents disclose techniques for ethanol production and foam control, which are all incorporated by reference in their entirety, as follows:

WO 2017/015361 discloses a technique for applying measurement, control, and automation to a dry corn milling ethanol production process to maximize the recovery of ethanol and co-products.

U.S. Pat. No. 5,437,842A discloses a foam control system.

U.S. Pat. No. 3,739,795A discloses a technique for detecting and controlling foamability of a liquid system.

U.S. Pat. No. 5,108,655A discloses a foam monitoring control system. WO2017200841A1 discloses a side-stream foam monitor and control system.

CN104707367A discloses an automatic defoaming control system of sugar mill and operating method of automatic defoaming control system.

CN107632625A discloses a computer metering device capable of automatically adding defoaming agent.

### SUMMARY OF THE INVENTION

In summary, the present invention provides a new technique for implementing an antifoam dosage on beet washing water that can be finely regulated based upon a set point of air measured by SONAR-based technology to ensure excellent control of foam, thus avoiding unnecessary product waste given by dosage set according to the worst-case scenario. The SONAR-based technology (also known as EchoWise™ (EW)) measures the volumetric percent of entrained gas (air), also named Gas Volume Fraction percentage (GVF %), in process waters used for beet washing. The GVF % value is proportional to the foam generated into the systems. A defoamer feed pump is configured so the product dosage is controlled in a cascading loop based on GVF % measured in the process fluid. This results in a reduction of defoamer usage in the range of 35%-40% and excellent control of entrained air thus foam in the whole process water system. The effect of upsets experienced during a process change has been dramatically reduced as the defoamer feed is automatically regulated resulting in excellent control of foam through a wide variety of conditions.

### Specific Embodiments

According to some embodiments, and consistent with that shown by way of example herein, the present invention may include, or take the form of, a beet washing system featuring a defoamer dosage controller having a signal processor configured to receive signaling containing information about a volumetric percent of entrained air in a process water used for washing beets; and determine corresponding signaling containing information to control a dosage of defoamer provided to the process water to regulate the amount of foam in the process water used for washing the beets.

The beet washing system may include one or more of the following features:

The beet washing system may include a SONAR-based sensing device configured to sense the entrained air in the process water used for washing the beets, determine a Gas Volume Fraction percentage (GVF %) and provide the signaling received by the signal processor of the defoamer dosage controller.

The GVF % may be proportional to the foam generated in the process water used for washing the beets.

The signal processor may be configured to keep a set point of GVF % determined to represent an absence of foam.

The dosage of the defoamer provided to the process water may be proportional to the amount of foam in the process water used for washing the beets.

The signal processor may be configured to provide the corresponding signaling as control signaling, e.g., to control one or more defoamer dosage pumps configured at one or more antifoam dosing points in the beet washing system.

The beet washing system may include one or more defoamer dosage pumps configured to receive the control signaling and provide the dosage of the defoamer to the process water to regulate the amount of foam in the process water used for washing the beets.

The beet washing system may include one or more antifoam dosing points, e.g., consistent with that disclosed herein. By way of example, the one or more antifoam dosing points may be configured in relation to the input or output of the clarifier, or in relation to the canal/channel either between accelerators and the beet silo, or between the accelerators and the washing station, etc.

### A Canal/Channel Antifoam Dosing Arrangement

The beet washing system may include a canal/channel configured to receive the process water and beets, e.g., provided from a beet silo; and a canal/channel antifoam dosing arrangement having a canal/channel SONAR-based sensing device configured to sense the entrained air in the process water flowing in the canal/channel, determine a Gas Volume Fraction percentage (GVF %) and provide the signaling received by the signal processor of the defoamer dosage controller.

The canal/channel antifoam dosing arrangement may also include a canal/channel defoamer dosage pump configured to receive the control signaling and provide the dosage of the defoamer to the process water flowing in the canal/channel to regulate the amount of foam in the process water used for washing the beets.

The canal/channel SONAR-based sensing device and the canal/channel defoamer dosage pump may be configured on the canal/channel.

### A Clarifier Inlet Antifoam Dosing Arrangement

The beet washing system may include a clarifier having an inlet configured to receive the process water and mud, and having an outlet configured to provide clarified process water; and a clarifier inlet antifoam dosing arrangement having a clarifier inlet SONAR-based sensing device configured to sense the entrained air in the process water flowing into the inlet of the clarifier, determine a Gas Volume Fraction percentage (GVF %) and provide the signaling received by the signal processor of the defoamer dosage controller.

The clarifier inlet antifoam dosing arrangement may also include a clarifier inlet defoamer dosage pump configured to receive the control signaling and provide the dosage of the defoamer to the process water flowing into the inlet of the clarifier to regulate the amount of foam in the process water used for washing the beets.

The clarifier inlet SONAR-based sensing device and the clarifier inlet defoamer dosage pump may be configured on the inlet of the clarifier.

### A Clarifier Outlet Antifoam Dosing Arrangement

The beet washing system may include a clarifier outlet antifoam dosing arrangement having a clarifier outlet SONAR-based sensing device configured to sense the entrained air in the clarified process water flowing from the outlet of the clarifier, determine a corresponding Gas Volume Fraction percentage (GVF %) and provide the signaling received by the signal processor of the defoamer dosage controller.

The clarifier outlet antifoam dosing arrangement may also include a clarifier outlet defoamer dosage pump configured to receive the control signaling and provide the dosage of the defoamer to the clarified process water flowing from the outlet of the clarifier to regulate the amount of foam in the process water used for washing the beets.

The clarifier outlet SONAR-based sensing device and the clarifier outlet defoamer dosage pump may be configured on the outlet of the clarifier.

### The Defoamer Dosage Controller

By way of example, the defoamer dosage controller may include, or take the form of, a centralized defoamer dosage controller having one or more signal processors for implementing the signal processing control functionality for one or more of the antifoam dosing arrangement disclosed herein. In this embodiment, the signaling is received by the signal processor in the centralized defoamer dosage controller from each of the one or more SONAR-based sensing devices.

Alternatively, and by way of further example, the defoamer dosage controller may include, or take the form of, one or more separate defoamer dosage controllers, each having a separate signal processor for each antifoam dosing arrangement disclosed herein. In this embodiment, the signaling is received by each separate signal processor in each separate defoamer dosage controller from each separate SONAR-based sensing device.

### The Cannons, Beet Silo and Washing Station

The beet washing system may include cannons configured to provide water for wetting the beets in the process water; and the beet silo configured to contain the beets for washing, receive the water for wetting the beets, and provide the process water and beets to the canal/channel for washing the beets.

The beet washing system may include a washing station configured to receive the process water and beets flowing in the canal/channel, provide washed beet for further processing, and provide the process water for further processing.

### Advantages

According to the present invention, a defoamer application on beet washing water can now be done automatically by fine-tuning the defoamer dosing pump output upon a setpoint of air measured by SONAR technology, which is proportional to the foam present into the system. The antifoam pumps react quickly to keep a set point of air (GVF %) previously determined to represent absence of foam. The dosage of antifoam would be now really proportional to the amount of foam present, avoiding unnecessary waste given by dosages covering the worst-case scenarios. Defoamer dosing systems driven by the amount of gas measured by the SONAR technology reduce the defoamer usage during routine operation, as well as during emergencies, and also reduce chemical residuals in process water, juices and syrups.

### BRIEF DESCRIPTION OF THE DRAWING

The drawing includes FIGS. 1-7, as follows:

FIG. 1 shows a block diagram of a beet washing system having a defoamer dosage controller with a signal processor or processing module for implementing the signal processing functionality to control a defoamer dosage pump, according to some embodiments of the present invention.

FIG. 2 shows a diagram of a beet washing system, according to some embodiments of the present invention.

FIG. 2A shows a canal/channel that receives process water and beets; and a canal/channel antifoam dosing arrangement having a canal/channel SONAR-based sensing device and a canal/channel defoamer dosage pump, according to some embodiments of the present invention.

FIG. 2B shows a clarifier having an inlet that receives process water and mud, an outlet that provides clarified process water, a clarifier inlet antifoam dosing arrangement having a clarifier inlet SONAR-based sensing device and a clarifier inlet defoamer dosage pump, and a clarifier outlet antifoam dosing arrangement having a clarifier outlet SONAR-based sensing device and a clarifier outlet defoamer dosage pump, according to some embodiments of the present invention.

FIG. 3 is a graph showing pump flow versus time (days) and GVF (%) versus time (days) over a 10 day period from September 17th thru 27th.

FIG. 4 is a graph showing pump flow versus time (days), GVF (%) versus time (days) and EchoWise (EW) flow versus time over a 6 day period from September 20th thru 26th.

FIG. 5 is a graph showing pump flow versus time (days) and GVF (%) versus time (days) over a 6 day period from September 20th thru 26th.

FIG. 6 is a graph showing pump flow versus time (days) and GVF (%) versus time (days) over a 6 day period from September 20th thru 26th.

FIG. 7 is a graph showing pump flow versus time (days) and GVF (%) versus time (days) over a 6 day period from September 20th thru 26th, including ranges of GVF reading only on day 1, GVF 12% set point on days 2 and 3, and GVF 10% set point on days 4 thru 6.

### DETAILED DESCRIPTION OF THE BEST MODE OF THE INVENTION

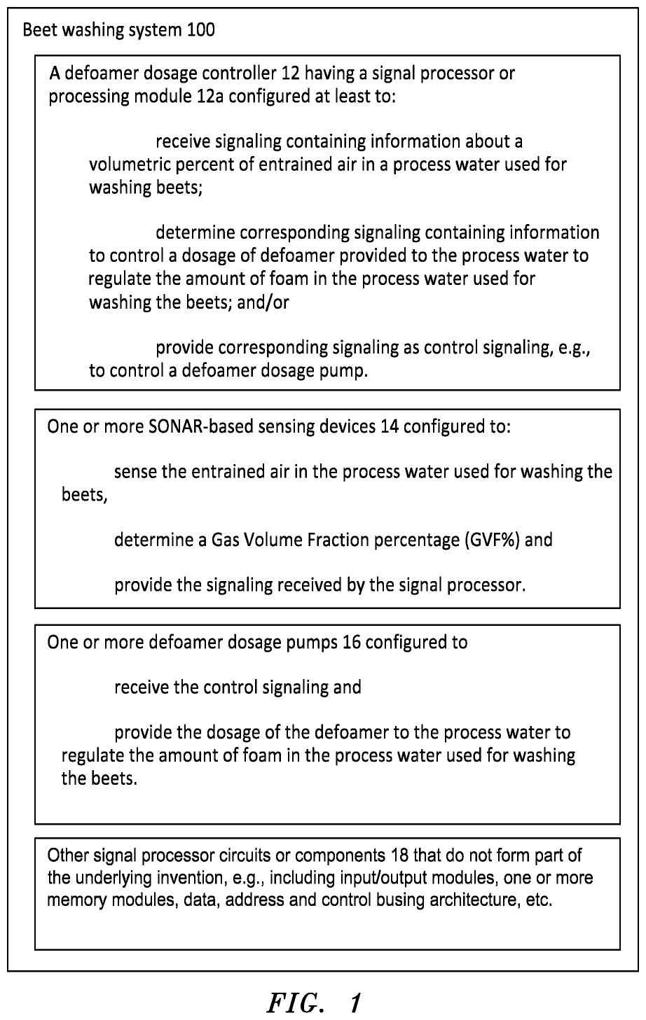

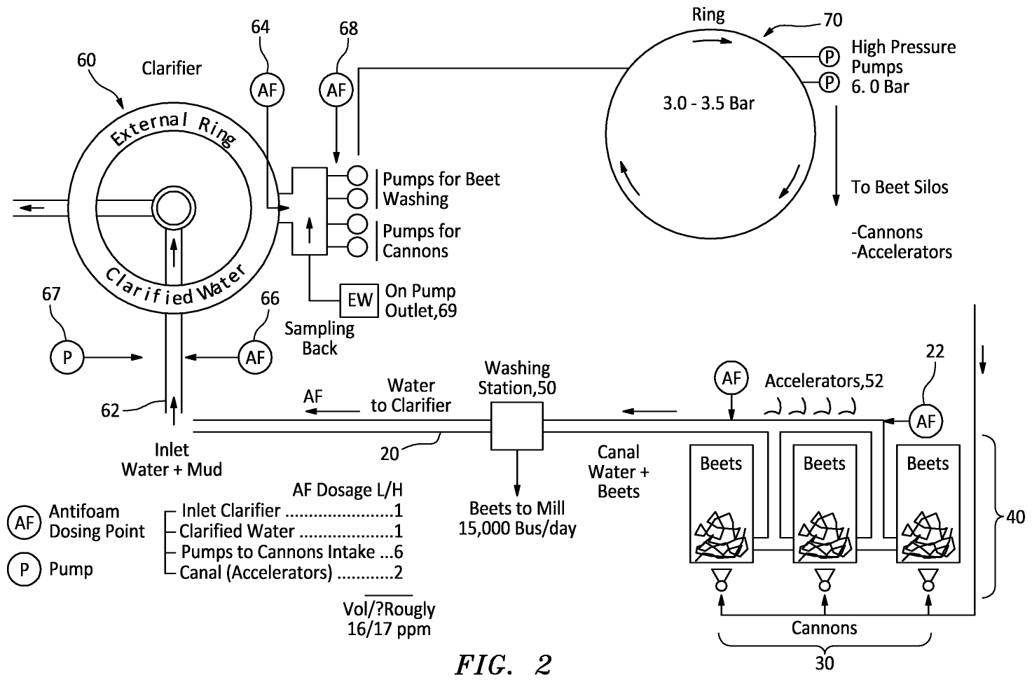

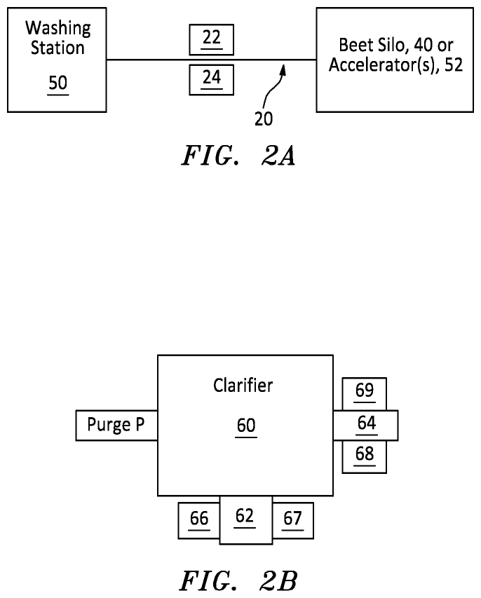

According to some embodiments, and consistent with that shown in FIGS. 1-2 by way of example below, the present invention may include, or take the form of, a beet washing system 10 featuring a defoamer dosage controller 12 having processor or processing module 12a configured to receive signaling containing information about a volumetric percent of entrained air in a process water used for washing beets; and determine corresponding signaling containing information to control a dosage of defoamer provided to the process water to regulate the amount of foam in the process water used for washing the beets.

The beet washing system 10 may include one or more SONAR-based sensing devices 14 configured to sense the entrained air in the process water used for washing the beets, determine a Gas Volume Fraction percentage (GVF %) and provide the signaling received by the signal processor 12a of the defoamer dosage controller 12.

The GVF % may be proportional to the foam generated in the process water used for washing the beets.

The signal processor 12a may be configured to keep a set point of GVF % determined to represent an absence of foam.

The dosage of the defoamer provided to the process water may be proportional to the amount of foam in the process water used for washing the beets.

The signal processor 12a may be configured to provide the corresponding signaling as control signaling, e.g., such as defoamer dosage control signaling to one or more defoamer dosage pumps 16.

The beet washing system 10 may include the one or more defoamer dosage pumps 16 configured to receive the control signaling and provide the dosage of the defoamer to the process water to regulate the amount of foam in the process water used for washing the beets.

The beet washing system 10 may include one or more antifoam dosing points, e.g., consistent with that shown in FIG. 2 and described below:

### FIGS. 2, 2A and 2B

The beet washing system 10 shown in FIG. 2 includes the following:
a canal/channel 20 configured to receive the process water and beets;
a canal/channel antifoam dosing arrangement having a canal/channel SONAR-based sensing device 22 and a canal/channel antifoam dosing pump 24 also shown in FIG. 2A;
cannons 30 configured to provide water for wetting the beets in the process water for providing to the canal/channel 20;
a beet silo 40 configured to contain the beets for washing, receive the water from the cannons 30 for wetting the beets, and provide the process water and beets to the canal/channel 20;
a washing station 50 configured to receive the process water and beets flowing in the canal/channel 20, provide washed beet for further processing, e.g., in a beet mill, and provide the process water and mud for further processing;
a clarifier 60 having an inlet 62 configured to receive the process water and mud from the washing station 50 for clarifying, a purge P configured to provide the mud clarified from the process water, and an outlet 64 configured to provide clarified process water, e.g., to one or more pumps for providing the clarified process water to the cannons 30, etc.;
a clarifier inlet antifoam dosing arrangement having a clarifier inlet SONAR-based sensing device 66 and a clarifier inlet antifoam dosing pump 67 shown in FIG. 2B; and
a clarifier outlet antifoam dosing arrangement having a clarifier outlet SONAR-based sensing device 68 and a clarifier outlet antifoam dosing pump 69 also shown in FIG. 2B.

### The Canal/Channel Antifoam Dosing Arrangement

By way of example, the canal/channel SONAR-based sensing device 22 may be configured to sense the entrained air in the process water flowing in the canal/channel, determine a canal/channel Gas Volume Fraction percentage (GVF %) and provide the signaling received by the signal processor 12a of the defoamer dosage controller 12.

By way of example, the canal/channel defoamer dosage pump 24 may be configured to receive the defoamer dosage control signaling (e.g., in the form of canal/channel defoamer dosage control signaling) and provide the dosage of the defoamer to the process water flowing in the canal/channel 20 to regulate the amount of foam in the process water used for washing the beets.

By way of example, the canal/channel SONAR-based sensing device 22 and the canal/channel defoamer dosage pump 24 may be configured on the canal/channel 20, e.g., using techniques known in the art. The scope of the invention is not intended to be limited to how the canal/channel SONAR-based sensing device 66 and the canal/channel defoamer dosage pump 67 are configured on the canal/channel 20.

### The Clarifier Inlet Antifoam Dosing Arrangement

By way of example, the clarifier inlet SONAR-based sensing device 66 may be configured to sense the entrained air in the process water flowing into the inlet 62 of the clarifier 60, determine a clarifier inlet Gas Volume Fraction percentage (GVF %) and provide the signaling received by the signal processor 12a of the defoamer dosage controller 12.

By way of example, the clarifier inlet defoamer dosage pump 67 may be configured to receive the defoamer dosage control signaling (e.g., in the form of clarifier inlet defoamer dosage control signaling) and provide the dosage of the defoamer to the process water flowing into the inlet 62 of the clarifier 60 to regulate the amount of foam in the process water used for washing the beets.

By way of example, the clarifier inlet SONAR-based sensing device 66 and the clarifier inlet defoamer dosage pump 67 may be configured on the inlet 62 of the clarifier 60, e.g., using techniques known in the art. The scope of the invention is not intended to be limited to how the clarifier inlet SONAR-based sensing device 66 and the clarifier inlet defoamer dosage pump 67 are configured on the inlet 62 of the clarifier 60.

### The Clarifier Outlet Antifoam Dosing Arrangement

By way of example, the clarifier outlet SONAR-based sensing device 68 may be configured to sense the entrained air in the clarified process water flowing from the outlet 64 of the clarifier 60, determine a clarifier outlet Gas Volume Fraction percentage (GVF %) and provide the signaling received by the signal processor 12a of the defoamer dosage controller 12.

By way of example, the clarifier outlet defoamer dosage pump 69 may be configured to receive the defoamer dosage control signaling (e.g., in the form of clarifier outlet defoamer dosage control signaling) and provide the dosage of the defoamer to the clarified process water flowing from the outlet 64 of the clarifier 60 to regulate the amount of foam in the process water used for washing the beets.

By way of example, the clarifier outlet SONAR-based sensing device 68 and the clarifier outlet defoamer dosage pump 69 may be configured on the outlet 64 of the clarifier 60, e.g., using techniques known in the art. The scope of the invention is not intended to be limited to how the clarifier outlet SONAR-based sensing device 68 and the clarifier outlet defoamer dosage pump 69 are configured on the outlet 64 of the clarifier 60.

### The Defoamer Dosage Controller 12

By way of example, the defoamer dosage controller 12 may include, or take the form of, a centralized controller having the signal processor 12a for implementing the signal processing control functionality for one or more of the antifoam dosing arrangement described herein. In this embodiment, the signaling is received by the signal processor 12a in the centralized controller from each of the one or more SONAR-based sensing devices like element 14.

Alternatively, and by way of further example, the defoamer dosage controller 12 may include, or take the form of, one or more a separate controller having a separate signal processor for each antifoam dosing arrangement described above. In this embodiment, the signaling is received by each separate signal processor in each separate controller from each separate SONAR-based sensing device like element 14.

By way of example, and consistent with that described herein, the functionality of the defoamer dosage controller 12 and the signal processor 12a may be implemented to receive the signaling containing information about a volumetric percent of entrained air in a process water used for washing beets; and determine the corresponding signaling containing information to control a dosage of defoamer provided to the process water to regulate the amount of foam in the process water used for washing the beets, using hardware, software, firmware, or a combination thereof, although the scope of the invention is not intended to be limited to any particular embodiment thereof. In a typical software implementation, the signal processor or processing module 12a may include, or take the form of, one or more microprocessor-based architectures having a microprocessor, a random access memory (RAM), a read only memory (ROM), input/output devices and control, data and address busing architecture connecting the same. A person skilled in the art would be able to program such a microprocessor-based implementation to perform the functionality set forth herein, as well as other functionality described herein without undue experimentation. The scope of the invention is not intended to be limited to any particular implementation using technology either now known or later developed in the future. Moreover, the scope of the invention is intended to include a signal processor, device or module 12a as either part of the aforementioned controller 12, as a stand alone module, or in the combination with other circuitry for implementing another module.

Techniques for receiving signaling in such a signal processor 12a are known in the art, and the scope of the invention is not intended to be limited to any particular type or kind thereof either now known or later developed in the future. Based on this understanding, a person skilled in the art would appreciate, understand and be able to implement and/or adapt the signal processor 12a without undue experimentation so as to receive signaling, and determining the corresponding signaling, consistent with that set forth herein.

It is also understood that the controller 12 may include, or operate in conjunction with, one or more other modules, components, processing circuits, or circuitry 18 for implementing other functionality associated with the underlying apparatus that does not form part of the underlying invention, and thus is not described in detail herein. By way of example, the one or more other modules, components, processing circuits, or circuitry may include random access memory, read only memory, input/output circuitry and data and address buses for use in relation to implementing the signal processing functionality of the signal processor, or devices or components, etc.

### Other Components Shown in FIG. 2

In FIG. 2, the beet washing system 10 includes some other components that do not form part of the underlying invention and are briefly described, as follows:

For example, the beet washing system 10 may include one or more accelerators 52 configured to accelerate the process water and beets flowing in the canal/channel 20 from the beet silo 40 to the washing station 50.

The washing station 50 provides the washed beets, e.g., to a beet, and provide the process water and mud washed from the beets to the clarifier 60.

The clarifier 60 provides the clarifier water to various pumps that pump the clarified water, e.g., to a ring 70 or pumps in the washing station 50, etc. The ring 70 pressurizes the clarified water and provides pressurized clarified water to the cannons 30, or the accelerators 52. By way of example, the ring 70 can pressurizes the clarified water from 3-3.5 bar, and provides the pressurized clarified water to high pressure pumps that further pressurize the clarified water, e.g., to 6.0 bar, for pumping to the cannons 30, or the accelerators 52, consistent with that shown in FIG. 2.

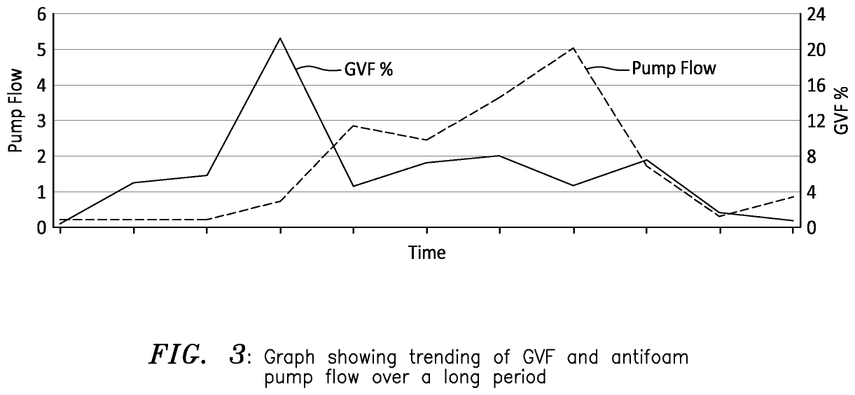

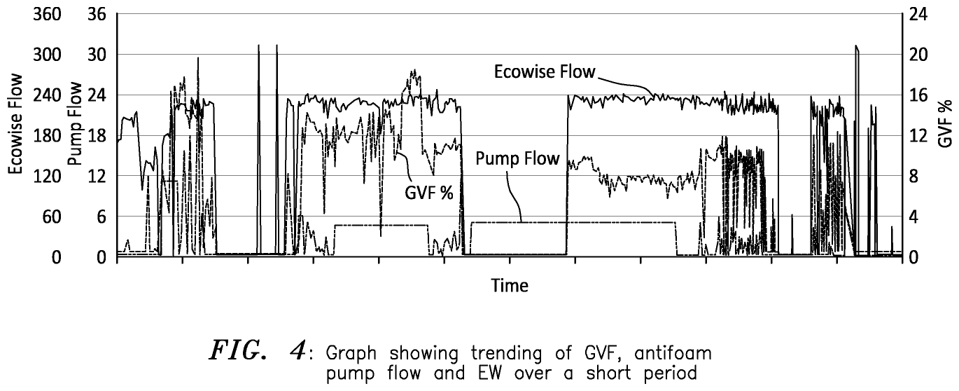

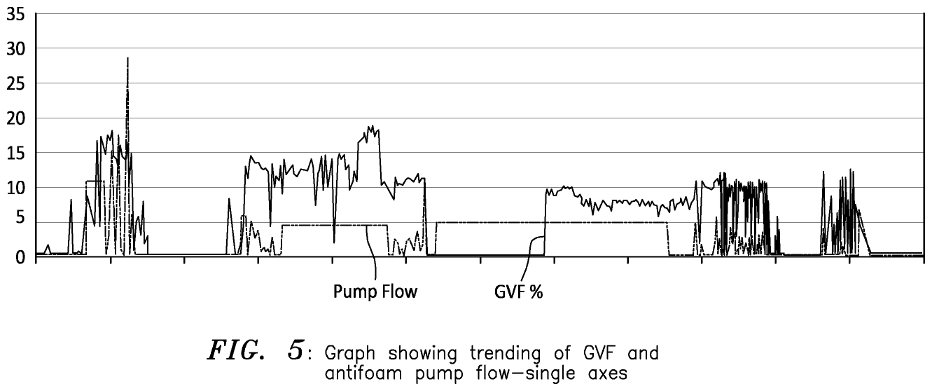

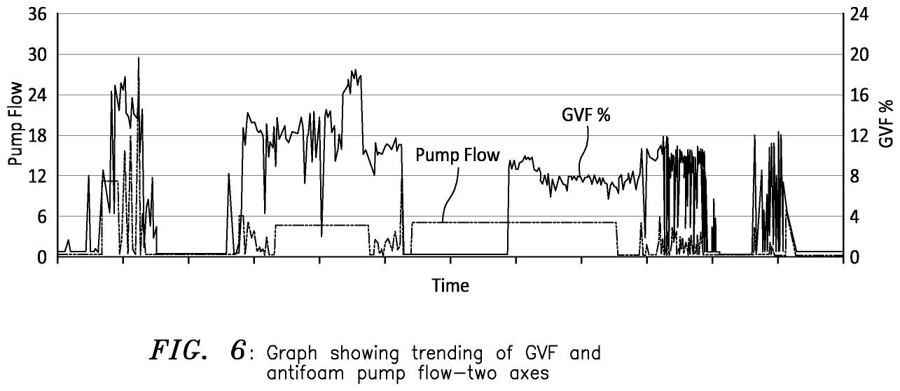

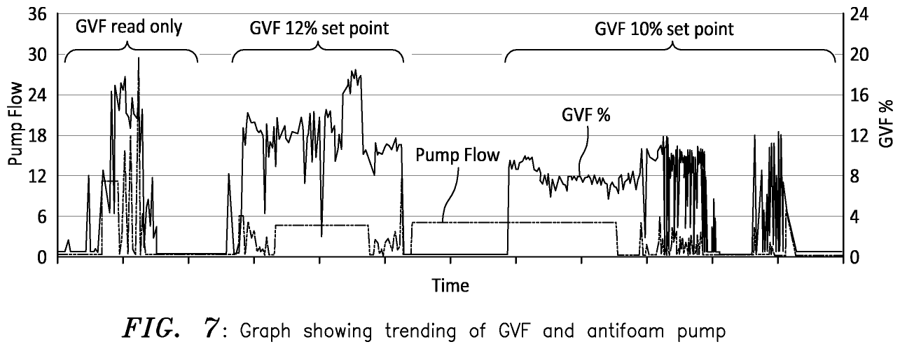

### FIGS. 3-7

FIGS. 3-7 show graphs of data recorded during testing of the beet washing system according to some embodiments of the present invention.

The testing during the period from Sep. 20-25, 2018 shows the best recording data.

Consistent with that shown in FIGS. 3-7, there were 3 periods of testing, reading and recording, as follows:
1: Reading by manual dosage of antifoam (AF),
2: Reading with Automatic AF dosage, GVF set point 12%
3: Reading with Automatic AF dosage, GVF set point 10%

It is noted that:
A straight line pump flow: Manual dosage (not on the set point) and
At GVF 10% set point: Frequent but low pump flow, to correct the value of GVF.

Moreover, it is also noted that the EW test of foam vs. air included testing for foam presence into the beet washing system with a range of three levels of foam presence, as follows:

Level 1: Absent—GVF below 10%
Few traces somewhere, decanter surface clean, decanter ring clean, no calls at all by operators, best conditions to work. Mode of operation: full preventative.

Level 2: Acceptable—GVF 10%-14%
Foam present, decanter with ⅓ of surface covered by foam, traces on ring, no calls at all by operators, acceptable conditions of working. Mode of operation: Optimized.

Level 3: Excess—GVF >15%
Foam present in all circuits, decanter with ⅔ of surface covered by foam, half of ring covered by foam, calls by operators after 2-3 hours, critical conditions of working. Mode of operation: Need correction soon (not urgent).

### Applications

In addition to the washing stage, the present invention can be used in other sections of the beet sugar process, as follows:
Diffusion—extraction step (raw juice production),
Purification (liming, carbonation, saturation stages),
Evaporation stage, concentrating thin juice to thick juice,
Boiling pans, crystallization,
Syrups,
Molasses, and
Sugar refining.

Embodiments are also envisioned in cane crushing and extraction stage for typical cane sugar processing (starting from purification all stages listed are basically identical to beet processing).

Other targeted industries where they may find foaming troubles, and EchoWise may be used in relation to the process controller on washing stages or other stages:
Potato washing,
Potato fries (a lot of defoamer use here),
Vegetables washing in general, and
Wheat processing for starch productions.

Protein separation in general, and fermentation, both aerobic and anaerobic.

### The SONAR-Based Sensor Technology

The SONAR-based sensing technology may include, or take the form of, one or more of the SONAR-based devices disclosed in one or more of the following patents: U.S. Pat. Nos. 6,354,147; 6,609,069; 6,889,562; 7,032,432; 7,086,278; 7,134,320; 7,152,460; 7,165,464; 7,261,002; 7,343,820; 7,363,800; 7,367,240 7,587,948; and 7,359,803, which are all incorporated by reference in their entirety.

### The Scope of the Invention

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is not intended that the invention be limited to the particular embodiment(s) disclosed herein as the best mode contemplated for carrying out this invention.

We claim:

1. A beet washing system, comprising:
a defoamer dosage controller having a signal processor configured to
receive signaling containing information about a volumetric percent of entrained air in a process water used for washing beets; and
determine corresponding signaling containing information to control a dosage of defoamer provided to the process water to regulate the amount of foam in the process water used for washing the beets.

2. A beet washing system according to claim 1, wherein the beet washing system comprises one or more SONAR-based sensing device configured to sense the entrained air in the process water used for washing the beets, determine a Gas Volume Fraction percentage (GVF %) and provide the signaling received.

3. A beet washing system according to claim 2, wherein the GVF % is proportional to the foam generated in the process water used for washing the beets.

4. A beet washing system according to claim 2, wherein the signal processor configured to keep a set point of GVF % determined to represent an absence of foam.

5. A beet washing system according to claim 1, wherein the dosage of the defoamer provided to the process water is proportional to the amount of foam in the process water used for washing the beets.

6. A beet washing system according to claim 1, wherein the signal processor is configured to provide the corresponding signaling as control signaling, including to control one or more defoamer dosage pumps.

7. A beet washing system according to claim 1, wherein the beet washing system comprises one or more defoamer dosage pumps configured to receive the control signaling and provide the dosage of the defoamer to the process water to regulate the amount of foam in the process water used for washing the beets.

8. A beet washing system according to claim 1, wherein the beet washing system comprises:
a canal/channel configured to receive the process water and beets; and
a canal/channel antifoam dosing arrangement having a canal/channel SONAR-based sensing device configured to sense the entrained air in the process water flowing in the canal/channel, determine a canal/channel Gas Volume Fraction percentage (GVF %) and provide the signaling received by the signal processor of the defoamer dosage controller.

9. A beet washing system according to claim 8, wherein the canal/channel antifoam dosing arrangement comprises a canal/channel defoamer dosage pump configured to receive the corresponding signaling and provide the dosage of the defoamer to the process water flowing in the canal/channel to regulate the amount of foam in the process water used for washing the beets.

10. A beet washing system according to claim 8, wherein the canal/channel SONAR-based sensing device and the canal/channel defoamer dosage pump are configured on the canal/channel.

11. A beet washing system according to claim 8, wherein the beet washing system comprises:
cannons configured to provide water for wetting the beets in the process water; and
a beet silo configured to contain the beets for washing, receive the water from the cannons for wetting the beets, and provide the process water and beets to the canal/channel.

12. A beet washing system according to claim 11, wherein the beet washing system comprises:
a washing station configured to receive the process water and beets flowing in the canal/channel, provide washed beet for further processing, and provide the process water for further processing.

13. A beet washing system according to claim 1, wherein the beet washing system comprises:
a clarifier having an inlet configured to receive the process water and mud, and having an outlet configured to provide clarified process water; and
a clarifier inlet antifoam dosing arrangement having a clarifier inlet SONAR-based sensing device configured to sense the entrained air in the process water flowing into the inlet of the clarifier, determine a clarifier inlet Gas Volume Fraction percentage (GVF %) and provide the signaling received by the signal processor of the defoamer dosage controller.

14. A beet washing system according to claim 13, wherein the clarifier inlet antifoam dosing arrangement comprises a clarifier inlet defoamer dosage pump configured to receive the corresponding signaling and provide the dosage of the defoamer to the process water flowing into the inlet of the clarifier to regulate the amount of foam in the process water used for washing the beets.

15. A beet washing system according to claim 13, wherein the clarifier inlet SONAR-based sensing device and the clarifier inlet defoamer dosage pump are configured on the inlet of the clarifier.

16. A beet washing system according to claim 13, wherein the beet washing system comprises:
a washing station configured to receive the process water and beets flowing in the canal/channel, provide washed beet for further processing, and provide the process water and mud for further processing in the clarifier.

17. A beet washing system according to claim 1, wherein the beet washing system comprises:
a clarifier outlet antifoam dosing arrangement having a clarifier outlet SONAR-based sensing device configured to sense the entrained air in the clarified process water flowing from the outlet of the clarifier, determine a clarifier outlet Gas Volume Fraction percentage (GVF %) and provide the signaling received by the signal processor in defoamer dosage controller.

18. A beet washing system according to claim 17, wherein the clarifier outlet antifoam dosing arrangement comprises a clarifier outlet defoamer dosage pump configured to receive the corresponding signaling and provide the dosage of the defoamer to the clarified process water flowing from the outlet of the clarifier to regulate the amount of foam in the process water used for washing the beets.

19. A beet washing system according to claim 17, wherein the clarifier outlet SONAR-based sensing device and the clarifier outlet defoamer dosage pump are configured on the outlet of the clarifier.
